(19) United States
(12) Patent Application Publication
(10) Pub. No.: US 2020/0296242 A1
(43) Pub. Date: Sep. 17, 2020

(54) SHEET CONVEYANCE DEVICE AND IMAGE READING DEVICE INCLUDING SAME

(71) Applicant: Konica Minolta, Inc., Tokyo (JP)

(72) Inventors: Akinori KIMATA, Toyokawa-shi (JP); Tatsuya EGUCHI, Toyohashi-shi (JP); Takeshi ISHIDA, Toyohashi-shi (JP); Takashi WATANABE, Toyokawa-shi (JP)

(21) Appl. No.: 16/816,802

(22) Filed: Mar. 12, 2020

(30) Foreign Application Priority Data
Mar. 15, 2019 (JP) . 2019-048838

(51) Int. Cl. H04N 1/00; B65H 43/00; B65H 29/20

(52) U.S. Cl. CPC H04N 1/00652; H04N 1/00602; B65H 2513/10; B65H 29/20; B65H 43/00

(57) ABSTRACT

A sheet conveyance device including: a conveyance roller that conveys a sheet; a motor that rotationally drives the conveyance roller at a constant speed; a central processing unit (CPU) that: periodically acquires temperature increase rates for the motor from a start of sheet conveyance, the temperature increase rates depending on magnitudes of effective current applied to the motor, the effective current depending on loads during sheet conveyance; and estimates a current temperature of the motor based on a cumulative value calculated from the temperature increase rates and time elapsed from the start of sheet conveyance; and a controller that executes a motor temperature control based on the estimated temperature of the motor.

### CROSS REFERENCE TO RELATED APPLICATIONS

The present invention claims priority 35 U.S.C. § 119 to Japanese Patent Application No. 2019-048838 filed Mar. 15, 2019, the contents of which are hereby incorporated herein by reference in their entirety.

### BACKGROUND

### (1) Technical Field

The present disclosure relates to sheet conveyance devices that convey sheets by conveyance rollers, and more specifically to an improvement in technology for estimating temperature of a motor driving a conveyance roller.

### (2) Related Art

An image reading device such as a scanner includes a document conveyance device, which is an example of a sheet conveyance device, that conveys a document to a reading position by a conveyance roller. The conveyance roller typically rotates by drive power of a drive motor such as a stepping motor (hereinafter also referred to simply as a “motor”).

In recent years there has been a demand for improvement in reading productivity in such image reading devices. As one method for improving reading productivity, a motor can be rotated at a higher speed to increase the number of documents conveyed per unit of time.

However, when a motor is rotated at a higher speed, an amount of heat generated by the motor increases, and the motor itself may be damaged by heating of the motor. As a structure for preventing a motor from generating too much heat, detecting and monitoring temperature of the motor using a sensor or the like, and stopping the motor to lower the temperature when the temperature exceeds a defined amount can be considered. However, this structure requires a means of detection such as a sensor for measuring actual temperature of the motor, and therefore an increase in cost is inevitable.

JP-H10-14096 describes a technology for estimating motor temperature without using a sensor or the like, in order to prevent damage to the motor in a document reading device. More specifically, various constants used in estimation of motor temperature are determined in advance for each operation mode such as a copy mode and a scan mode, and when power is on, a motor's current temperature is estimated by adding a constant corresponding to an executed operation mode to a motor temperature variable.

### SUMMARY

However, according to the technology described in JP-H10-14096, a constant is determined for each operation mode, and therefore, for example, even if more than one type of document is conveyed in the scan mode, such as plain paper and thick paper, the same constant is applied.

Even if documents are the same size, if weights of the documents are different such as in the case of plain paper and thick paper, load torque of the motor via a conveyance roller will be different, and variance in the load torque causes variance in effective current applied to the motor to continue to rotate at a constant speed. When effective current applied to a motor varies, the amount of heat generated by the motor varies accordingly.

For this reason, there is a problem that accuracy of estimating motor temperature cannot be increased in a structure in which uniform addition of constants is applied regardless of document type, as described in JP-H10-14096.

This problem occurs not only when types of document are different from each other, but also when weights of documents are different because sizes of documents are different from each other, such as A3 and A5 size. Further, this problem is not limited to conveyance of documents, and may occur in typical sheet conveyance devices that convey sheets, including documents.

An object of the present disclosure is to provide a sheet conveyance device and an image reading device that can estimate the temperature of a motor with higher accuracy.

To achieve at least the abovementioned object, a sheet conveyance device according to an aspect of the present disclosure is a sheet conveyance device including: a conveyance roller that conveys a sheet; a motor that rotationally drives the conveyance roller at a constant speed; and a central processing unit (CPU) that: periodically acquires temperature increase rates for the motor from a start of sheet conveyance, the temperature increase rates depending on magnitudes of effective current applied to the motor, the effective current depending on loads during sheet conveyance; and estimates a current temperature of the motor based on a cumulative value calculated from the temperature increase rates and time elapsed from the start of sheet conveyance; and a controller that executes a motor temperature control based on the estimated temperature of the motor.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the invention. In the drawings:

FIG. 1 is a schematic diagram illustrating structure of a multi-function peripheral (MFP) pertaining to at least one embodiment.

FIG. 2 is a side-view diagram illustrating a schematic structure of an image reading device in an MFP.

FIG. 3 is a block diagram illustrating structure of an overall controller.

FIG. 4 is a block diagram illustrating structure of a first motor controller.

FIG. 5 is a block diagram illustrating structure of a motor temperature estimator.

FIG. 6 is a diagram illustrating content of a motor temperature change rate table.

FIG. 7A is a diagram illustrating an example of a current waveform flowing through a drive motor when a load torque is small, and FIG. 7B is an example of a current waveform flowing through a drive motor when the load torque is large.

FIG. 8 is a diagram illustrating an example of a timing chart where two documents are sequentially fed and read one by one.

FIG. 9 is a flowchart illustrating content of motor start temperature setting processing.

FIG. 10 is a flowchart illustrating content of motor temperature calculation processing.

FIG. 11 is a flowchart illustrating content of motor temperature calculation processing.

FIG. 12 is a flowchart illustrating content of temperature increase suppression operation instruction processing.

FIG. 13 is a graph schematically illustrating temperature increases of motors in an embodiment and a reference example.

FIG. 14 is a diagram illustrating an example of a current waveform flowing through a drive motor when a conveyance speed is low.

### DETAILED DESCRIPTION

The following describes an embodiment of a sheet conveyance device and an image reading device incorporating the sheet conveyance device pertaining to the present disclosure, with reference to the drawings and taking a multi-function peripheral (MFP) as an example.

### (1) Overall Structure of MFP

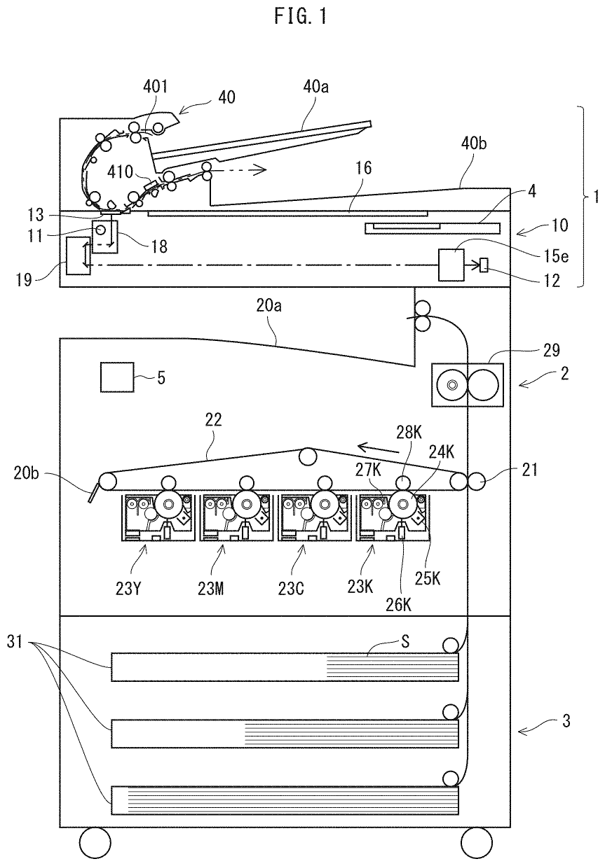

FIG. 1 is a schematic diagram illustrating structure of an MFP pertaining to at least one embodiment.

As illustrated, the MFP includes an image reading device 1, an image former 2, a sheet feeder 3, an operation unit 4, and an overall controller 5.

The image reading device 1 has a structure to be able to read a document image by a sheet-through method using a single fixed optical system and a scanner moving method using a moving optical system. Here, the sheet-through method is a method of reading a document being conveyed (moved) while an optical system is stationary (fixed) at a fixed reading position. The scanner moving method is a method of reading a stationary document while a mirror that guides light reflected from a surface of the document to a reading sensor is moved relative to the document while maintaining a constant optical path length from the surface of the document to the reading sensor.

The image reading device 1 of the present embodiment in the sheet-through method can sequentially read images of a first side (front side) and a second side (back side) of one document in one conveyance operation, or in other words is a one-pass duplex image reading device.

In the sheet-through method, a user can select a single-side reading mode for reading only an image of one side of a document or a both-sides reading mode for reading images of both sides. Details of reading operations by the sheet-through method and the scanner moving method are provided later.

The image former 2 forms an image based on image data read by the image reading device 1, and includes an intermediate transfer belt 22, imaging units 23Y, 23M, 23C, 23K, a fixing unit 29, and the like.

The imaging units 23Y, 23M, 23C, 23K are arranged along the intermediate transfer belt 22, and form toner images in the colors yellow (Y), magenta (M), cyan (C), and black (K), respectively. The imaging units 23Y, 23M, 23M, 23K have the same structure, and therefore only the imaging unit 23K is described here.

The imaging unit 23K includes a photosensitive drum 24K, a charger 25K, an exposure unit 26K, a developer unit 27K, and a primary transfer roller 28K. An outer circumferential surface of the photosensitive drum 24K is uniformly charged by the charger 25K. The exposure unit 26K emits a light beam towards the photosensitive drum 24K according to a drive signal based on image data read by the image reading device 1, exposing the charged surface of the photosensitive drum 24K to form an electrostatic latent image on the photosensitive drum 24K.

The electrostatic latent image formed on the outer circumferential surface of the photosensitive drum 24K is developed with toner by the developer unit 27K, and the toner image is electrostatically transferred onto the intermediate transfer belt 22 by the primary transfer roller 28K. On the intermediate transfer belt 22, the Y, M, C, K toner images are superimposed to form a color toner image.

In parallel with the toner image forming operation, the sheet feeder 3 feeds out sheets S one by one from any one of sheet feed cassettes 31 housed in the sheet feeder 3, to be conveyed to a secondary transfer position where a secondary transfer roller 21 is disposed. The secondary transfer roller 21 electrostatically transfers the toner image on the intermediate transfer belt to the sheet S.

The sheet S onto which the toner image is transferred is melted and fixed to the sheet S by heat and pressure at the fixing unit 29, then discharged onto a discharge tray 20a. Residual toner on the intermediate transfer belt 22 that isn't transferred onto the sheet S is removed by a cleaner 20b.

The operation unit 4 is disposed at a position where a user can easily operate it. The operation unit 4 accepts input from a user such as selection of a reading mode for a document and an instruction to start reading, and notifies the overall controller 5 of input received.

The overall controller 5 controls the image reading device 1, the image former 2, and the sheet feeder 3 to execute a job based on input information from a user. For example, when a user selects a both-sides reading mode for a document, the image reading device 1 is controlled to execute document conveyance by the sheet-through method, and an image reading operation is executed for both a first side and a second side of a document during conveyance of the document.

### (2) Image Reading Device Structure

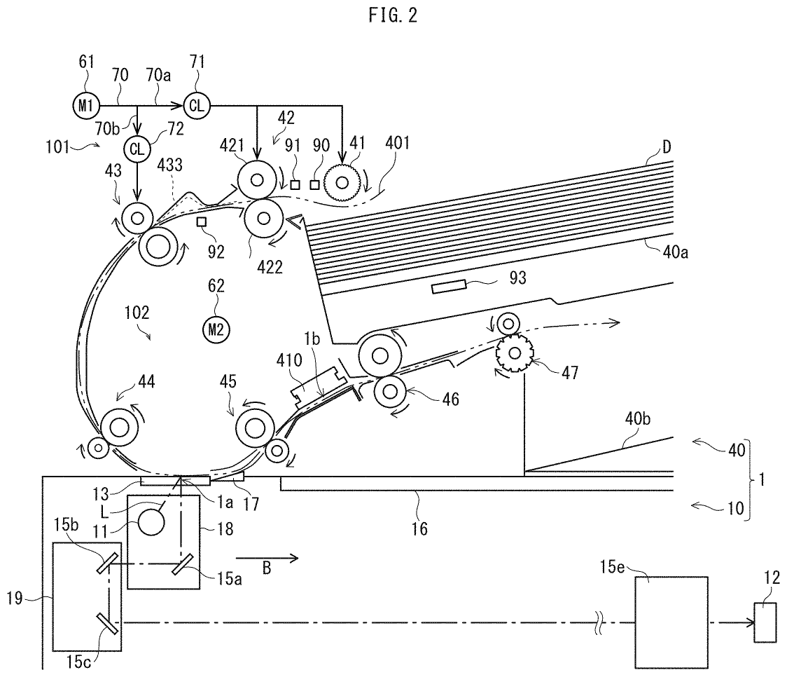

FIG. 2 is a side view illustrating a schematic structure of an image reading device 1.

As illustrated, the image reading device 1 includes an image reader 10 in a top surface of which is glass 13 for the sheet-through method and a platen glass 16, and an automatic document feeder (ADF) 40 above the image reader 10.

### (2-1) Image Reader Structure

The image reader 10 includes a first slider 18 on which are a lamp 11 and a first mirror 15a, a second slider 19 on which are a second mirror 15b and a third mirror 15c, a condenser lens 15e, and a charge coupled device (CCD) sensor 12 as a reading sensor.

When reading a document by the sheet-through method, the image reader 10 reads an image of a first surface of a document D when the document D conveyed by the ADF 40 passes over the glass 13 (where the first surface is a surface of the document D that faces the glass 13).

More specifically, the first slider 18 is moved to and stopped directly under the glass 13 (a sheet-through position). Then the lamp 11 is switched on, and light L from the lamp 11 irradiates the first surface of the document D as it passes over the glass 13.

Reflected light from the first surface of the document D has its optical path changed by the first mirror 15a, the second mirror 15b, and the third mirror 15c, and is imaged on a light receiving surface of the CCD sensor 12 by the condenser lens 15e. The CCD sensor 12 generates image data corresponding to the image of the first surface of the document D by photoelectric conversion of received light, and sends the generated image data to the image former 2.

On the other hand, when scanning a document by the scanner moving method, first a user opens the ADF 40 upwards and places the document on the platen glass 16, and in this state the lamp 11 is switched on and the first slider 18 is moved in a direction indicated by an arrow B in FIG. 2. When the first slider 18 moves, the second slider 19 moves in the same direction at half the speed of the first slider 18. As a result, light reflected from the document is imaged on the light receiving surface of the CCD sensor 12 while a distance (optical path length) from the document on the platen glass 16 to the condenser lens 15e is kept constant.

### (2-2) ADF Structure

The ADF 40 includes a sheet conveyance device that, when a document image is read by the sheet-through method, conveys documents D on a document feed tray 40a one sheet at a time along a document conveyance path 401, to pass over the glass 13 and be discharged onto a document discharge tray 40b.

More specifically, the document D placed on the document feed tray 40a is fed to the document conveyance path 401 by the feed roller 41 and is conveyed to a separation roller pair 42. The document D fed out by the feed roller 41 is detected by a sheet feed sensor 91 disposed in the vicinity of the conveyance path 401 on the way to the separation roller pair 42.

The sheet feed sensor 91 is, for example, a reflection-type optical sensor including a light emitter and a light receiver. Light emitted from the light emitter towards the document conveyance path 401 is reflected at the document D being conveyed. When this reflected light is received by the light receiver, the sheet feed sensor 91 outputs a signal indicating detection of the document D, here an “H level” signal, and when reflected light is not received, the sheet feed sensor 91 outputs a signal indicating non-detection of the document D, here an “L level” signal. By monitoring this signal level, whether or not the document D is at the detection position of the sheet feed sensor 91 can be detected.

A document type detection sensor 90 for detecting a type of the document D being conveyed is disposed next to the sheet feed sensor 91. Here, “type” means plain paper, thick paper, thin paper, and the like. The document type detection sensor 90 is, for example, a transmissive-type optical sensor including a light emitter and a light receiver. Of light emitted from the light emitter, only light transmitted through the document D is received by the receiver. The document type detection sensor 90 outputs a signal indicating a magnitude of light received by the receiver. Thick paper is thicker than plain paper and therefore transmits less light. By correlation in advance of types of document D with signal values indicating magnitudes of light, the type of the document D being conveyed can be identified from a signal value.

In a structure in which a user can manually input document type from the operation unit 4, the document type can be determined from information input by a user.

The separation roller pair 42 includes a sheet feed roller 421 and a separation roller 422 rotating in the same direction as each other, such that directions of movement at a point of contact between the sheet feed roller 421 and the separation roller 422 are opposed, in order that the documents D conveyed between the sheet feed roller 421 and the separation roller 422 are separated and sent one by one to a resist roller pair 43.

After passing through the separation roller pair 42, the document D is detected by a resist sensor 92 disposed in the vicinity of the conveyance path 401 on the way to a resist roller pair 43. The resist sensor 92 is an optical sensor similar to the sheet feed sensor 91. Based on detection of the document D by the resist sensor 92, skew correction of the document D described below is executed.

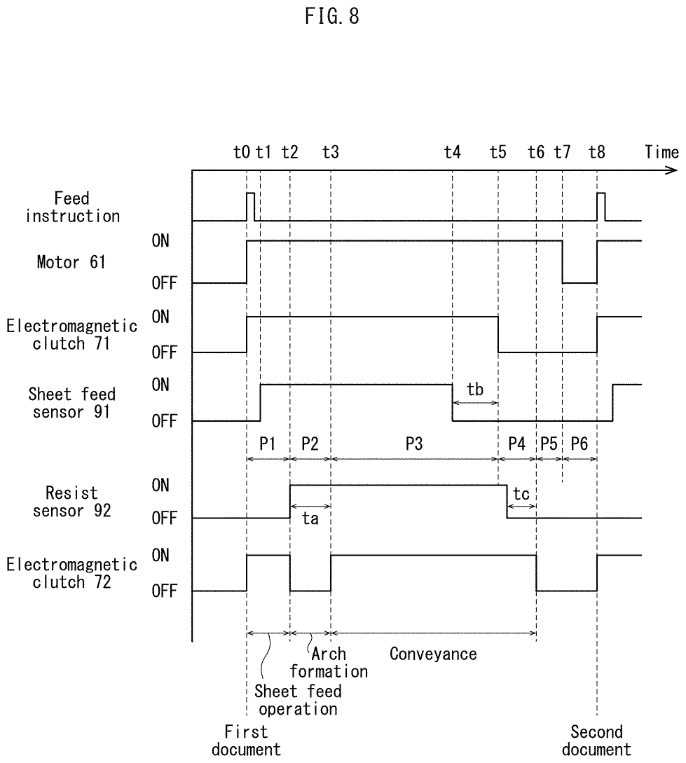

When the resist sensor 92 detects the document D, the resist roller pair 43 are temporarily stopped. At this time the sheet feed roller 421 continues to rotate. When a leading end of the document D abuts against a nip of the temporarily stopped resist roller pair 43 (where the opposed rollers contact each other), further progress of the leading end of the document D is prevented. As a result, an arch 433 (indicated by a dotted line) is formed in the document D on an upstream side in the conveyance direction of the resist roller pair 43. The formation of the arch 433 causes a restoring force that acts on the document D to return to its original flat state, pressing the leading end of the document D against the nip of the resist roller pair 43 and thereby eliminating skew of the leading end of the document D (skew correction). Rotation of the resist roller pair 43 is resumed at a defined timing after the skew correction is completed (time t3 in FIG. 8, described later).

Due to resumption of rotation of the resist roller pair 43, the document D is conveyed towards a first conveyance roller pair 44. The first conveyance roller pair 44 conveys the document D sent from the resist roller pair 43 further downstream in the conveyance direction to pass a reading position 1a on the glass 13. When passing the reading position 1a, a first side image of the document D is read by the image reader 10.

The document D that has passed over the glass 13 is guided by a scoop guide 17 towards a second conveyance roller pair 45 obliquely above the glass 13. The second conveyance roller pair 45 applies a conveyance force in a direction further downstream in the document conveyance direction to the document D that has passed over the glass 13, and conveys the document D towards a contact image sensor (CIS) 410.

When the document D conveyed by the second conveyance roller pair 45 passes a reading position 1b immediately below the CIS 410, a second side image of the document D (the side facing the CIS 410) is read by the CIS 410 and image data corresponding to the second side image is generated. The generated image data is sent to the image former 2.

The document D, after passing the CIS 410, is conveyed to a discharge roller pair 47 via a pre-discharge roller pair 46. The discharge roller pair 47 discharges the document D conveyed from the pre-discharge roller pair 46 onto the document discharge tray 40b.

A size of the document D on the document feed tray 40a is detected by a document size detection sensor 93 of known design, and information on detected size of the document D is sent to the image former 2. The image former 2 forms an image by feeding a sheet S from a sheet feed cassette 31 that stores sheets S of the same size as the detected document D among the sheet feed cassettes 31. Further, size of the detected document D is used in jam detection and the like, with respect to the document D being conveyed. A structure that allows a user to manually input document size using the operation unit 4 allows a size input by a user to be acquired as the size of the document D.

The feed roller 41, the separation roller pair 42, and the resist roller pair 43 used in conveying the document D are rotationally driven by transmission of a driving force of a drive motor 61 via a drive transmission path 70 that includes a gear train, a belt, and the like (not illustrated). The drive transmission path 70 branches into two, a branch path 70a connected to the feed roller 41 and the separation roller pair 42 and a branch path 70b connected to the resist roller pair 43.

The drive motor 61 is a small stepping motor. A part of the driving force of the drive motor 61 is transmitted to the feed roller 41 and the separation roller pair 42 via the branch path 70a and a remainder of the driving force of the drive motor 61 is transmitted to the resist roller pair 43 via the branch path 70b.

Partway along the branch path 70a of the drive transmission path 70 is an electromagnetic clutch 71 for switching on and off transmission of driving force of the drive motor 61 to the feed roller 41 and the separation roller pair 42, and partway along the branch path 70b is an electromagnetic clutch 72 for switching on and off transmission of driving force of the drive motor 61 to the resist roller pair 43.

A conveyance mechanism that conveys the document D by rotating the feed roller 41, the separation roller pair 42, and the resist roller pair 43 by the driving force of the drive motor 61 is referred to as a first conveyance mechanism 101. Further, when it is not necessary to distinguish between the feed roller 41, the separation roller pair 42, and the resist roller pair 43, they may be referred to hereinafter as conveyance rollers.

The first conveyance roller pair 44, the second conveyance roller pair 45, the pre-discharge roller pair 46, and the discharge roller pair 47 are rotationally driven by a driving force of a drive motor 62 transmitted through a drive transmission path (not illustrated). The drive motor 62 is a DC brushless motor. A conveyance mechanism that conveys the document D by rotating the first conveyance roller pair 44, the second conveyance roller pair 45, the pre-discharge roller pair 46, and the discharge roller pair 47 by the driving force of the drive motor 62 is referred to as second conveyance mechanism 102.

The overall controller 5 executes rotation control of the drive motors 61, 62 and switching on and off of the electromagnetic clutches 71, 72.

### (3) Structure of Overall Controller

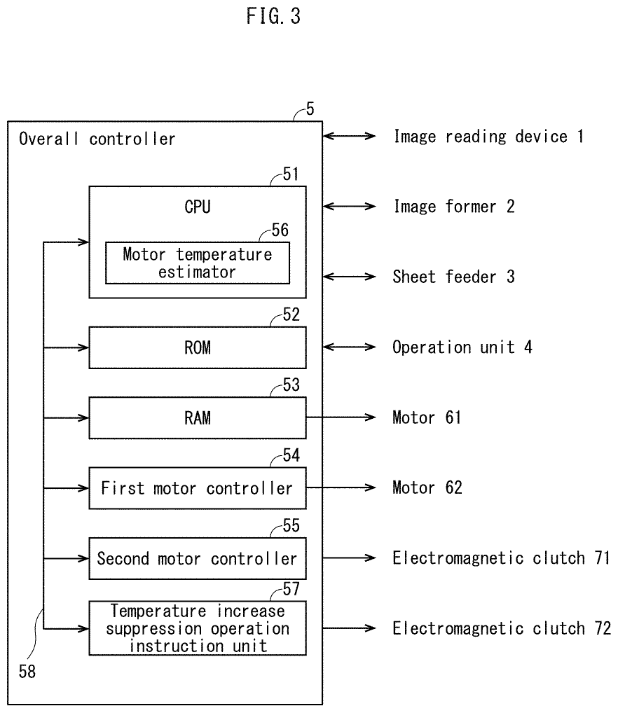

FIG. 3 is a block diagram illustrating structure of the overall controller 5.

As illustrated in FIG. 3, the overall controller 5 includes a central processing unit (CPU) 51, a read-only memory (ROM) 52, a random access memory (RAM) 53, a first motor controller 54, a second motor controller 55, and a temperature increase suppression operation instruction unit 57, each of which can exchange data and information through a bus 58.

The CPU 51 reads a required program from the ROM 52, uniformly controls operations and timings of the image reading device 1, the image former 2, and the sheet feeder 3, and causes execution of print operations based on document image data read by the image forming device 1. The RAM 53 is a work area of the CPU 51. The CPU 51 includes a motor temperature estimator 56.

The first motor controller 54 controls rotation of the drive motor 61.

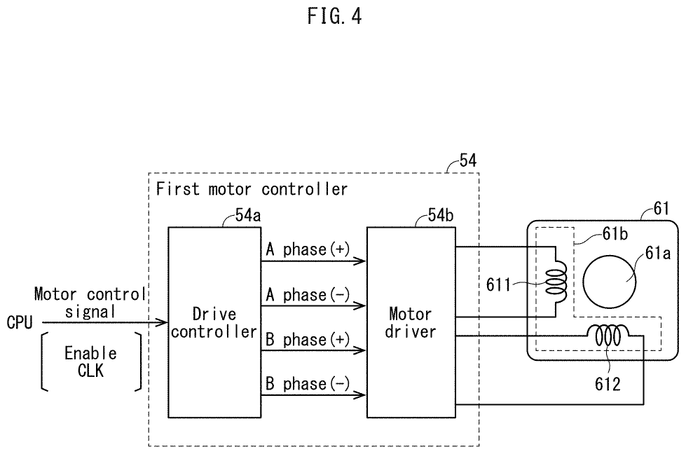

FIG. 4 is a block diagram illustrating structure of the first motor controller 54.

As illustrated in FIG. 4, the first motor controller 54 includes a drive controller 54a and a motor driver 54b, which can be integrally structured as an integrated circuit.

The motor driver 54b is a driver that drives a rotor 61a by passing a current through an armature 61b of the drive motor 61 that is a stepping motor. More specifically, a rotating magnetic field that rotates the rotor 61a is generated by applying a periodically changing alternating current (AC) voltage (pulse waveform) to an A phase coil (winding) 611 and a B phase coil 612 of the armature 61b. A rectangular wave is used as the AC voltage, but the AC voltage waveform is not limited to this example. The rectangular wave can be obtained by periodically switching on and off the output voltage of a constant voltage source, or by periodically inverting polarity of the output voltage.

The drive controller 54a controls the motor drive 54b according to an instruction included in a motor control signal input from the CPU 51. The CPU 51 issues the instruction when executing a document reading job. The instruction includes an enable signal instructing driving to switch on and off, and a variable frequency clock (CLK) for determining rotation speed.

Based on an instruction from the CPU 51, the drive controller 54a controls output of the motor driver 54b through a switching control signal A phase+, A phase—that instructs on and off switching of current of the A phase coil 611 and a switching control signal B phase+, B phase—that instructs on and off switching of current of the B phase coil 612 in order to rotate the drive motor 61 at a rotation speed according to the instruction from the CPU 51 or to stop the drive motor 61.

Returning to FIG. 3, the second motor controller 55 is a controller that controls rotation of the drive motor 62, which is a DC brushless motor, in order that the drive motor 62 continues rotating at a constant rotation speed from a start of feeding a first sheet of the documents D until a last sheet of the documents D is discharged by the discharge roller pair 47.

The motor temperature estimator 56 estimates temperature of the drive motor 61. According to the present embodiment, a stepping motor having a small step angle that can finely control a conveyance amount of the document D is used as the drive motor 61 of the first conveyance mechanism 101, such that a size of the arch to be formed in the document D is kept within a design range. On the other hand, the second conveyance mechanism 102 employs a relatively inexpensive DC brushless motor for the drive motor 62 because the document D may be conveyed at a constant speed by the second conveyance mechanism 102. Typically, a stepping motor is more likely to be damaged by heat generation than a DC brushless motor, and therefore temperature estimation is executed only for the drive motor 61 that is a stepping motor.

The temperature increase suppression operation instruction unit 57 monitors temperature of the drive motor 61 and controls temperature of the drive motor 61. More specifically, when the temperature of the drive motor 61 reaches a threshold value of 105° C., for example, the temperature increase suppression operation instruction unit 57 instructs the first motor controller 54 to execute a defined temperature increase suppression operation for suppressing temperature increase of the motor instead of a normal document conveyance operation.

The temperature increase suppression operation is an operation for reducing the number of documents D to be conveyed per unit time when compared to the normal document conveyance operation. Here, a time from completion of conveyance of an Nth document until a start of feeding an (N+1)th document (document feeding interval: corresponding to period P6 in FIG. 8) is changed to a longer time than in the normal document conveyance operation.

For example, if the document feeding interval in the normal document conveyance operation is 1 second, the document feeding interval may be extended to 5 seconds to 10 seconds in the temperature increase suppression operation. By stopping a motor for an extended time while continuing the document conveyance operation, it is possible to prevent temperature of the motor from rising and to control the temperature appropriately. An appropriate length of the document feeding interval is determined in advance by experiments or the like so that motor temperature does not exceed a threshold value.

Other methods may be used as long as the motor can be controlled at an appropriate temperature. For example, a time (several minutes) required for motor temperature to drop to a defined value that is about 10° C. lower than a threshold value may be determined in advance, the motor may be stopped until that time has elapsed to temporarily interrupt a document conveyance operation, and document conveyance may be resumed after that time has elapsed.

### (4) Structure of Motor Temperature Estimator

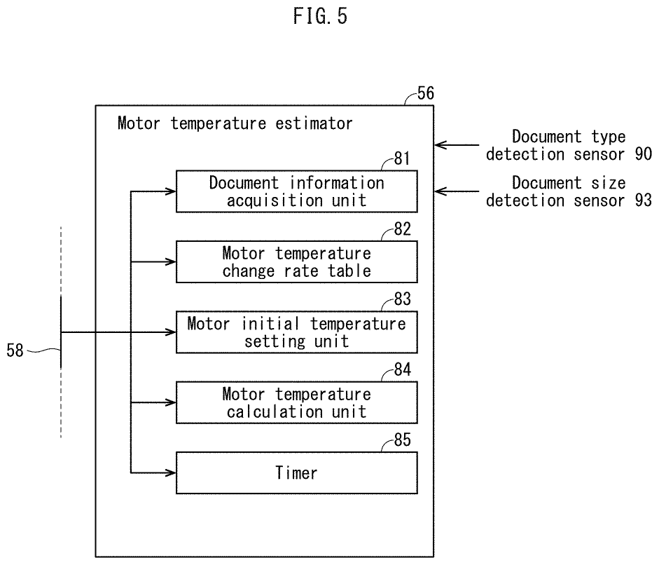

FIG. 5 is a block diagram illustrating structure of the motor temperature estimator 56.

As illustrated in FIG. 5, the motor temperature estimator 56 includes a document information acquisition unit 81, a motor temperature change rate table 82, a motor initial temperature setting unit 83, a motor temperature calculation unit 84, and a timer 85.

The document information acquisition unit 81 acquires document information including size and type of the document D and conveyance speed for each document D to be conveyed.

The document size is acquired by acquiring a detection result of the document size detection sensor 93. Document type includes plain paper, thick paper, and thin paper, and the document type is acquired by acquiring a detection result of the document type detection sensor 90. In a structure in which a user inputs document size and document type from the operation unit 4, it may suffice to acquire the input information. The document conveyance speed is determined in advance according to the document type. For example, thin paper is lighter than plain paper or thick paper, and therefore the document conveyance speed is a fixed amount faster than a reference speed corresponding to plain paper or thick paper.

The motor temperature change rate table 82 is a nonvolatile storage that stores information such as temperature increase rate and temperature decrease rate of the drive motor 61 corresponding to the type and size of the document included in the document information.

The motor initial temperature setting unit 83 sets the temperature of the drive motor 61 (motor initial temperature) at the start of rotation of the drive motor 61.

The motor temperature calculation unit 84 calculates the current temperature of the drive motor 61 using the motor initial temperature and the temperature increase rate and the temperature decrease rate of the motor temperature change rate table 82.

### (5) Content of the Motor Temperature Change Rate Table

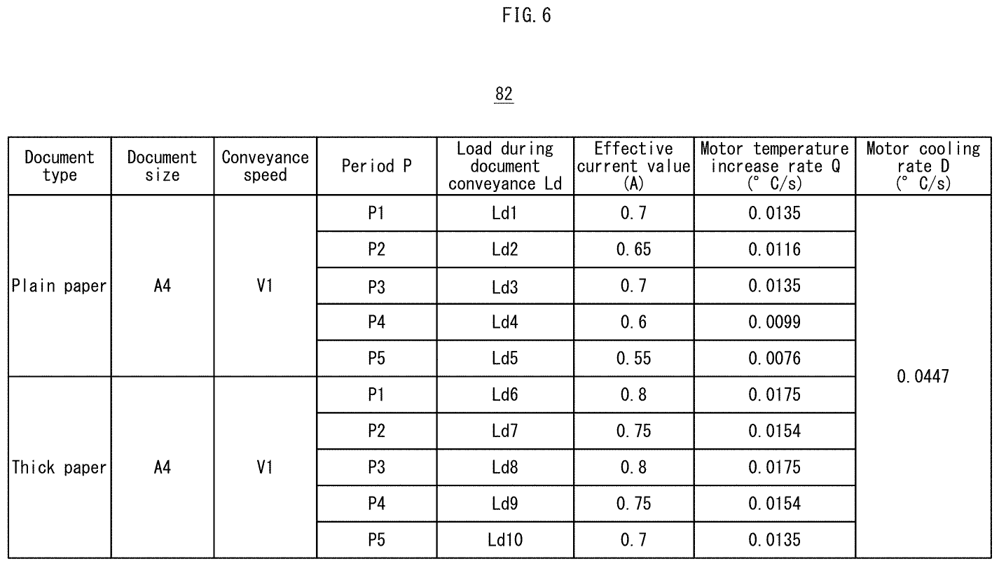

FIG. 6 is a diagram illustrating content of the motor temperature change rate table 82.

As illustrated in FIG. 6, the motor temperature change rate table 82 includes document type, document size, document conveyance speed, period P, load during document conveyance Ld, effective current value E, motor temperature increase rate Q, and motor cooling rate D, variously correlated.

The period P indicates periods P1 to P5 obtained by dividing conveyance of one document D in the first conveyance mechanism 101 from the start of conveyance into five periods in order.

The load during document conveyance Ld corresponds to load torque (motor load torque) applied to a rotation shaft of the drive motor 61, and varies during conveyance of the document D according to a combination of which conveyance rollers of the first conveyance mechanism 101 (conveyance system) are rotated at which times and which electromagnetic clutches are switched on and off at which times.

The effective current value E indicates magnitude of an effective value of current flowing in the coils 611, 612 of the drive motor 61. The motor temperature increase rate Q indicates a rate of temperature increase per unit time during the rotation of the drive motor 61. The motor cooling rate D indicates a rate of temperature drop per unit time when the drive motor 61 stops rotating (electrical current supply is cut off). The load during document conveyance Ld, the effective current value E, the motor temperature increase rate Q, and the motor cooling rate D are obtained in advance through experimentation or the like.

When document types are different, even if document size is the same, weight per unit area is different due to a difference in thickness, and therefore a difference occurs in rotational load of each conveyance roller (torque required to rotate the roller) in the first conveyance mechanism 101 according to the weight difference.

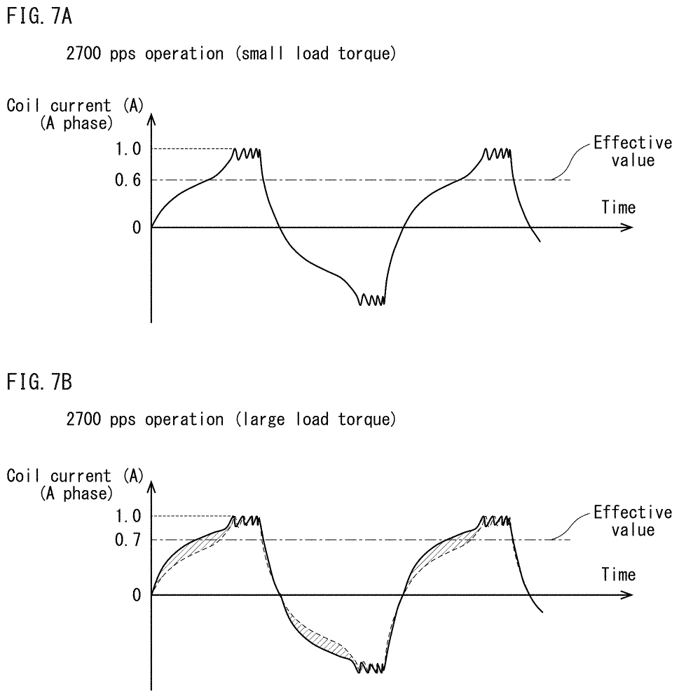

When there is a difference in rotational load of a conveyance roller, the motor load torque of the drive motor 61 that imparts drive force to the conveyance roller changes, and a magnitude of effective current flowing through the drive motor 61 changes in order to continue rotating at a specified constant speed. This is described in more detail with reference to FIG. 7A and FIG. 7B.

FIG. 7A illustrates an example of a current waveform flowing through the drive motor 61 (stepping motor) when a document type to be conveyed is plain paper and motor load torque is small due to the small rotational load on conveyance rollers.

On the other hand, FIG. 7B illustrates an example of a current waveform flowing through the drive motor 61 when a document type to be conveyed is thick paper that puts a greater rotational load on conveyance rollers than plain paper, and therefore the motor load torque is increased. In both FIG. 7A and FIG. 7B, rotational speed of the drive motor 61 is the same at 2700 pps, and the frequency of alternating current flowing in the coils of the drive motor 61, here in A phase, is the same and has the same peak value (amplitude: 1.0 A).

In FIG. 7A, the effective value of the current is 0.6 A because the motor load torque is small, but in FIG. 7B, the effective value of the current is 0.7 A because the motor load torque is increased. In order to maintain rotation speed under the condition that the peak value of the supplied current is constant (1.0 A) and to compensate for the increase in the motor load torque, induced current flows through the coils 611, 612 such that an area of the current waveform is increased over the area illustrated in FIG. 7A by a hatched portion illustrated in FIG. 7B.

Thus, when rotation loads of conveyance rollers are different, magnitudes of motor load torque vary, and effective values (effective current values) of current flowing in the coils 611, 612 of the drive motor 61 vary due to the variance in motor load torque. When the effective current value varies, magnitudes of Joule heat generated when current flows through internal resistance of the drive motor 61 are different. As a result, amounts of heat generated by the drive motor 61 are different, and temperature increase rates of the drive motor 61 are also different.

In FIG. 6, when the document type is plain paper, in the period P1, the load during document conveyance is Ld1, the effective current value E is 0.7, and the motor temperature increase rate Q is 0.0135, but when the document type is thick paper, in the same period P1, the load is Ld6, which is larger than Ld1, and as a result the effective current value E is 0.8 and the motor temperature increase rate Q is 0.0175, which is larger than for plain paper. Similar differences apply for the period P2 and other periods.

Here, the motor temperature increase rate Q can be obtained as follows. When the motor current is I and internal resistance is R, a motor power consumption is W=I²×R. For example, assuming that R=1.4Ω, I=0.6 A, and W=0.504 W, and that Q=0.0099 under these conditions, these values can be used as a reference. The motor temperature increase rate can be calculated for each motor current other than 0.6 A based on the proportional relationship between motor current and motor temperature increase rate.

The above description relates to document types, but even if document size are different, rotation loads of conveyance rollers are different. As a result, loads during document conveyance Ld, effective current values E, and temperature increase rates Q of the drive motor 61 are different.

For example, if a document is A4 size plain paper and a conveyance speed is V1, in period P1 the motor temperature increase rate Q is 0.0135, but if a document is B4 size plain paper and the conveyance speed is V1, the motor temperature increase rate Q increases from 0.0135 proportionally to the increase in load during document conveyance Ld when compared to A4, for example to 0.0175.

Thus, it can be said that differences in type and size of a document are conditions changing load during document (sheet) conveyance, or in other words motor load torque, and the loads during document conveyance are determined for each combination of type and size.

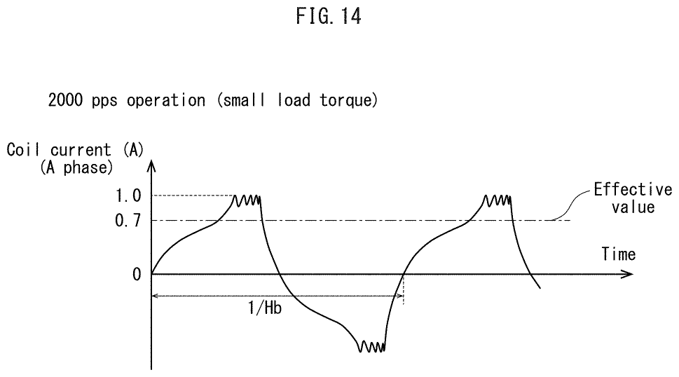

Further, if the conveyance speed of the document D is changed from V1 to a slower speed V2, the frequency of the current waveform is reduced. More specifically, assuming that the rotational speed of 2700 pps illustrated in FIG. 7A is the conveyance speed V1, and V2<V1, a control is executed to reduce the corresponding rotational speed to, for example, 2000 pps. According to this control, as illustrated in FIG. 14, the frequency of the current waveform changes from a frequency Ha corresponding to 2700 pps to a frequency Hb (<Ha) corresponding to 2000 pps.

Even when this control is executed, even when document conveyance speed is changed without changing document D type or size, the peak value of supplied current (current waveform amplitude) remains at 1.0 A. At the rotational speed of 2000 pps, at the peak value of 1.0 A remaining the same as for 2700 pps, the frequency is lower than for 2700 pps, and therefore the effective value of the current actually increases compared to the case of 2700 pps. This is caused by a reduction in motor efficiency. That is, when a stepping motor is used, there is a relationship that the effective value of current flowing through the drive motor 61 changes when the document conveyance speed changes. From this, it can be said that a difference in document conveyance speed is one of the conditions for changing motor load torque.

The following is a more detailed description of the periods P1 to P5 with reference to the timing chart illustrated in FIG. 8.

FIG. 8 is a diagram illustrating an example of a timing chart where two documents D are sequentially fed and read one by one. As illustrated, the drive motor 61 is switched on and the electromagnetic clutches 71, 72 are switched on in response to a sheet feed instruction (time t0). As a result, the feed roller 41, the separation roller pair 42, and the resist roller pair 43 start to rotate, and the first document D is fed out from the sheet feed tray 40a (feed start). From the feed start, when a leading end of the first document D is detected by the sheet feed sensor 91 (time t1) and then detected by the resist sensor 92 (time t2), the electromagnetic clutch 72 is switched off. Thus, only the resist roller pair 43 are stopped. This period from time to to time t2 is the period P1.

In the period P1, all of the feed roller 41, the separation roller pair 42, and the resist roller pair 43 are rotating at the same time, and therefore the load during document conveyance Ld1 is large, and the motor load torque increases by an amount proportional to the total rotation load of three conveyance rollers. As a result, as can be seen for the period P1 in FIG. 6, the effective current value is 0.7 A, and the motor temperature increase rate Q is 0.0135, which are larger values than those for periods P2, P4, P5.

Returning to FIG. 8, when a defined time ta elapses from detection of the leading end of the first document D by the resist sensor 92 at time t2 (time t3), the electromagnetic clutch 72 is switched from off to on. Thus, rotation of the resist roller pair 43 is resumed. The define time ta is determined in advance as a time required for form an arch in the leading end of the first document D (dotted line 433 in FIG. 2). This period from time t2 to time t3 is the period P2.

In the period P2, only the resist roller pair 43 are temporarily stopped, and therefore the total rotation load from conveyance rollers is reduced by this reduction in number of rotating conveyance rollers when compared to the three conveyance rollers rotating in the period P1. In FIG. 6, this is the load during document conveyance Ld2 in the period P2, but Ld2 is a smaller value than Ld1 in the period P1. Further, in the period P2, the effective current value E is 0.65 A and the motor temperature increase rate Q is 0.0116, which are smaller values than in the period P1.

That is, when the electromagnetic clutch 72 is switched on and off, a total conveyance load by each conveyance roller in the conveyance system changes, and the motor load torque changes accordingly, and therefore the effective current load E of the drive motor 61 changes. For this reason, switching between on and off periods of the electromagnetic clutch 72 is also one of the conditions for changing the load during document conveyance Ld, and included as one of the conditions for changing the motor load torque during sheet conveyance, or in other words the effective current value flowing through the drive motor 61.

Returning to FIG. 8, in the period P3 from time t3 to time t5, all of the feed roller 41, the separation pair 42, and the resist roller pair 43 are rotating at the same time. Thus, the rotation load of the conveyance rollers in the period P3 is the same as in the period P1, and as illustrated in FIG. 6, the load during document conveyance Ld3 in the period P3 is the same amount as Ld1 in the period P1, and the effective current value E and the motor temperature increase rate Q are the same as in the period P1.

From the feed sensor 91 switching from on to off (time t4), in other words from a trailing end of the first document D passing the detection position of the feed sensor 91, after a defined time tb elapses (time t5), the electromagnetic clutch 71 switches from on to off. The defined time tb is determined in advance as a time required for the trailing end of the document D to pass through the separation roller pair 42 after the feed sensor 91 switches off. The feed roller 41 and the separation roller 42 are temporarily stopped by the electromagnetic clutch 71 switching off.

From the resist sensor 92 switching from on to off (time t5), in other words from the trailing end of the first document D passing the detection position of the resist sensor 92, after a defined time tc elapses (time t6), the electromagnetic clutch 72 switches from on to off. The defined time tc is determined in advance as a time required for the trailing end of the document D to pass through the resist roller pair 43 after the resist sensor 92 switches off. The resist roller pair 43 are temporarily stopped by the electromagnetic clutch 72 switching off.

In the period P4 from time t5 to time t6, only the resist roller pair 43 rotates, and rotation load of conveyance rollers in the period P4 is smaller than in the period P2 in which the feed roller 41 and the separation roller pair 42 rotate. As a result, as illustrated in FIG. 6, in the period P4, the load during document conveyance Ld4 is smaller than Ld2 in the period P2, and the effective current value E and the motor temperature increase rate Q are smaller than in the period P2.

In the period P5 from time t6 to time t7, the drive motor 61 is rotating but all the conveyance rollers are stopped, so there is almost no conveyance roller rotation load in the period P5. As illustrated in FIG. 6, in the period P5, the load during document conveyance Ld5 is smaller than any of Ld1 to Ld4 in the periods P1 to P4, and the effective current value E and the motor temperature increase rate Q are smaller than in the periods P1 to P4.

In the period P6 from time t7 to a feed start instruction for the second document D (time t8), the drive motor 61 is stopped, and therefore the drive motor 61 does not increase in temperature, but cools. The cooling rate D is 0.0447 as illustrated in FIG. 6.

When there is a feed start instruction for the second document D (time t8), the same operations as executed for the feed start instruction for the first document D are started, that is, operations such as starting rotation of the drive motor 61 and switching on the electromagnetic clutches 71, 72.

For the first document D, the periods P1 to P5 are a temperature increasing period of the drive motor 61, and the period P6 is a cooling period of the drive motor 61.

When the temperature of the drive motor 61 at time t0 is an initial temperature TO, when the temperature increase rate Q in the period P1 is multiplied by the elapsed time from time t0 then added to the initial temperature TO, the temperature of the drive motor 61 (motor temperature) can be obtained. Similarly, when the temperature increase rate Q in the period P2 is multiplied by the elapsed time from time t2 then added to the motor temperature obtained at time t2, the motor temperature at the elapsed time can be obtained. The same applies for times t3 to t7. Further, when the cooling rate D in the period P6 is multiplied by the elapsed time from time t7 then subtracted from the motor temperature obtained at time t7, the motor temperature at the elapsed time can be obtained.

A temperature increase period starts from time t8 when the second document D is fed, but the motor temperature at each time after time t8 can be obtained by using the same temperature calculation method used in temperature increase periods and cooling periods with respect to the first document D.

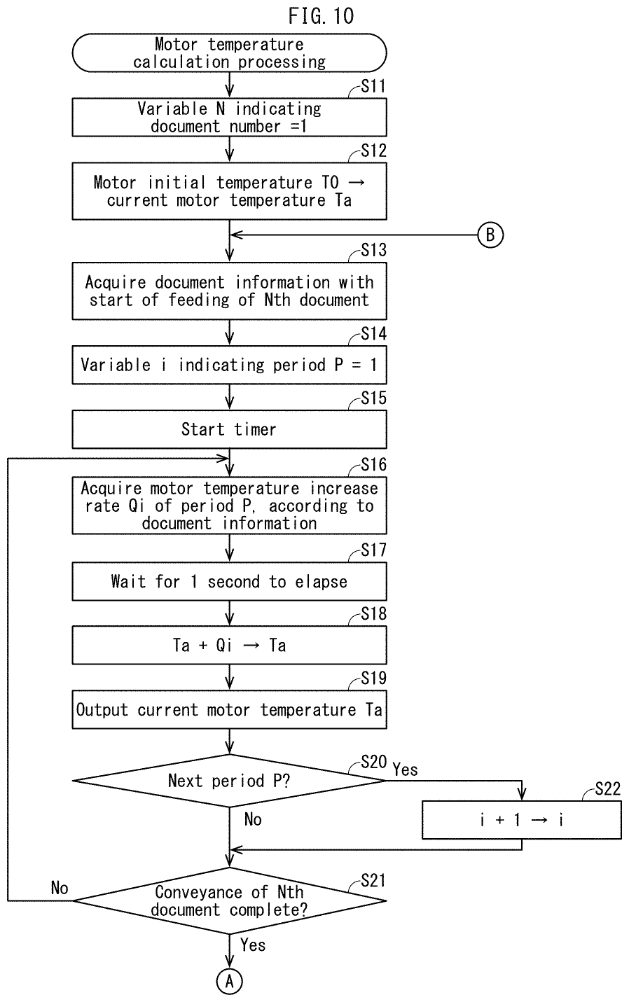

When sequentially feeding more than 2 documents D, the same operation as the feed operation for the second document D is repeated for each of the third and subsequent documents D. In such a case, the same temperature calculation method is used as when the first and second documents D are conveyed, and the motor temperature can be calculated for each time while the third and subsequent documents D are conveyed. The processing of the temperature calculation method is described later with reference to the flowchart illustrated in FIG. 10.

In FIG. 8, the drive motor 61 is stopped during the period P6 from time t7 to time t8, but the present disclosure is not limited to this example. When subsequent document to be conveyed is present, the drive motor 61 may continue rotating without being stopped. In such a case, the motor temperature increase rate Q is the same as in the period P5.

### (6) Motor Initial Temperature Setting

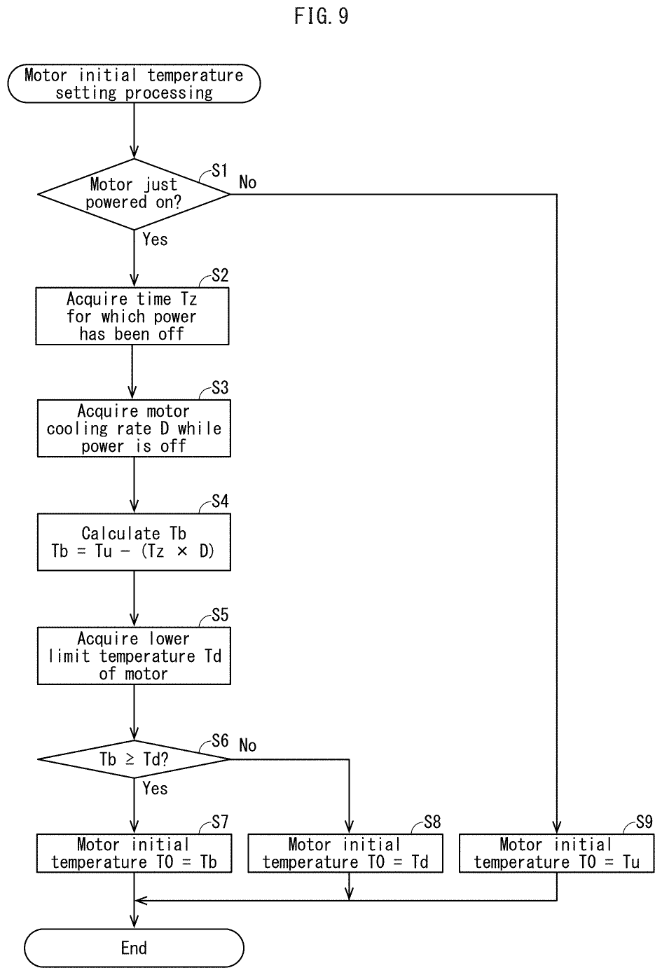

FIG. 9 is a flowchart illustrating content of motor initial temperature setting processing. The motor initial temperature setting processing is at the start of feeding the first document D and is executed by the motor initial temperature setting unit 83 immediately before the subsequent motor temperature calculation processing.

As illustrated, Whether or not the MFP has just been powered on is determined (step S1). If the MFP has just been powered on (“Yes” in step S1), a time Tz for which power has been off is acquired (step S2). The time Tz is measured by the timer 85.

Then the motor cooling rate D of the drive motor 61 while the power is off is acquired (step S3). This acquisition is performed by reading the motor cooling rate D from the motor temperature change rate table 82. Then a value Tb is obtained by subtracting (time Tz×motor cooling rate D) from an upper limit temperature Tu (step S4). Here, the upper limit temperature Tu is determined in advance as an assumed maximum value of initial temperature when current is flowing through the drive motor 61, and is 100° C., for example.

(Time Tz×motor cooling rate D) is the temperature drop of the drive motor 61 during a power-off period. Assuming that motor temperature at the previous power-off was the upper limit temperature Tu, the value Tb represents the motor temperature at the next power-on.

Then a lower limit temperature Td of the drive motor 61 is acquired (step S5). The lower limit temperature Td is determined in advance as an assumed minimum value of initial temperature of the drive motor 61 when the MFP is installed in a room temperature and humidity environment and is, for example, 35° C.

If temperature Tb≥lower limit temperature Td (“Yes” in step S6), the motor initial temperature TO is set to Tb (step S7), and processing ends. If temperature Tb<lower limit temperature Td (“No” in step S6), the motor initial temperature TO is set to Td (step S8), and processing ends. If the time Tz is very long, the calculation in step S4 may have a negative result even if the actual motor temperature is about the lower limit temperature Td, but setting the motor initial temperature TO to Td avoids this.

On the other hand, if the MFP has not just been powered on (“No” in step S1), the motor initial temperature TO is set to the upper limit temperature Tu (step S9), and processing ends. According to the present embodiment, motor temperature is not actually measured, and therefore it is not known to what extent the motor temperature drops while the MFP is powered on. The upper limit temperature Tu is a maximum value of initial temperature that is not expected to increase further, and therefore by setting this value as the motor initial temperature TO, it can be ensured that a threshold value (=105° C.) at which actual motor temperature increase suppression control would be executed is not exceeded.

### (7) Motor Temperature Calculation Processing

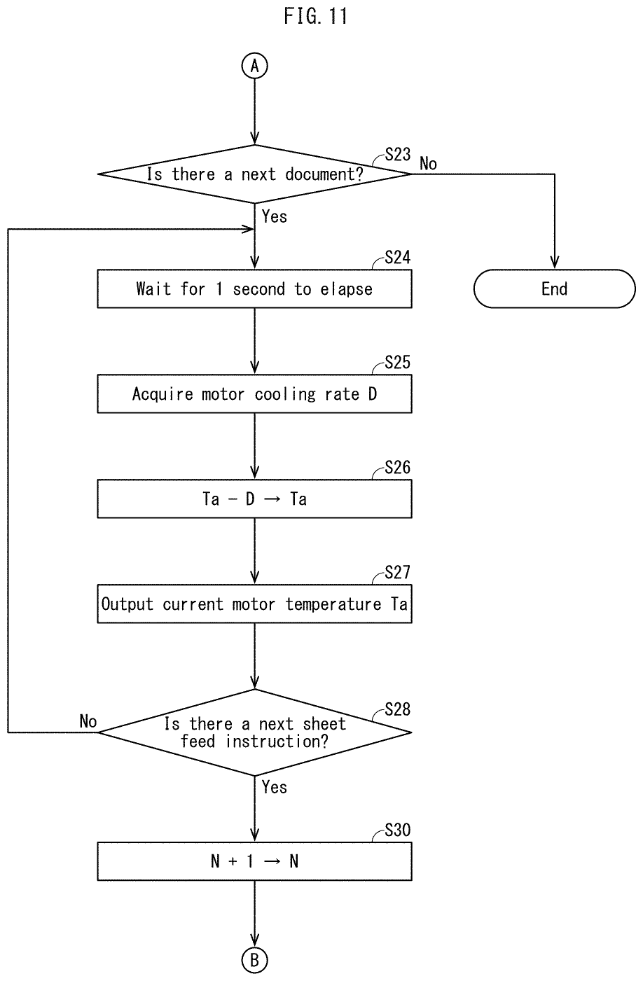

FIG. 10 and FIG. 11 are flowcharts illustrating content of motor temperature calculation processing. The motor temperature calculation processing is started by the motor temperature calculation unit 84 when feeding of the first document D is started.

As illustrated in FIG. 10, a variable N indicating document number is set to “1” (step S11). Then a current motor temperature Ta is set to the motor initial temperature TO set in the motor initial temperature processing (step S12).

Then document information is acquired with the start of feeding of the Nth document, here the first document D (step S13). Document information includes type, size, and conveyance speed of the first document, and is acquired by the document information acquisition unit 81.

Then a variable i indicating the period P is set to “1” (step S14). Then the timer 85 starts measuring time (step S15). Then, according to the document information acquired in step S13, the motor temperature increase rate Qi in the period Pi, here Q1 and P1, is acquired (step S16). Referring to the motor temperature change rate table 82 illustrated in FIG. 6 for the motor temperature increase rate Q (° C./s), the motor temperature increase rate Q1 for the period P1 corresponding to the document information (document type, size, conveyance speed) is read out. For example, if the first document D is plain paper, A4 size, at conveyance speed V1, “0.0135” is acquired as the motor temperature increase rate Q1 corresponding to the period P1.

After waiting for 1 second to elapse (step S17), the motor temperature increase rate Q1 acquired 1 second ago is added to the motor temperature Ta to obtain a new value for the motor temperature Ta (step S18). The motor temperature increase rate Q indicates an amount of increase in motor temperature in a 1 second unit, and therefore after 1 second has elapsed, the current motor temperature can be obtained by adding the motor temperature increase rate Q to the motor temperature Ta 1 second before.

Motor temperature information indicating the current motor temperature Ta is output to the temperature increase suppression operation instruction unit 57 (step S19). The temperature increase suppression operation instruction unit 57 acquires the current motor temperature from the received motor temperature information, and determines whether or not an instruction to execute the temperature increase suppression operation is necessary, based on the acquired motor temperature. The determination is described later.

Then it is determined whether or not the current time is in the next period Pi, in this example whether or not the current time is in the period P2 following the period P1 (step S20). If in the period P1, a negative determination is made (“No” in step S20), it is then determined whether or not conveyance of the Nth document, in this example the first document D, is complete (step S21). This processing is for document conveyance by the first conveyance mechanism 101, and a determination that document conveyance is complete is made when determining that time t7 as illustrated in FIG. 8 has been reached.

If it is determined that conveyance of the first document D is not complete, or in other words the conveyance operation is ongoing (“No” in step S21), processing returns to step S16 and processing from step S16 is executed. If the current time is still in the period P1, processing from step S16 to S21, returning to step S16, is repeatedly executed. As a result, the motor temperature increase rate Q1 accumulates every second from the start to the end of the period P1, the accumulated value is obtained as the additional motor temperature at that time, and output as the motor temperature information.

When the end of the period P1 (time t2 as illustrated in FIG. 8) is determined (“Yes” in step S20), the variable i is incremented by 1 to obtain a new value for the variable i (step S22). In the example described here, i=1, and therefore i is updated to 2.

Returning to step S16 via step S21, the motor temperature increase rate Qi for the period Pi is acquired, here the motor temperature increase rate Q2 for the period P2. If the document is plain paper, A4 size, conveyed at conveyance speed V1, the motor temperature increase rate Q2 in the period P2 is acquired as 0.0116.

After waiting for 1 second to elapse (step S17), the motor temperature increase rate Q2 acquired 1 second ago is added to the motor temperature Ta to obtain a new value for the motor temperature Ta (step S18). This method is the same as used in the period P1. While the current time is in the period P2, processing from step S16 to S21, returning to step S16, is repeatedly executed. As a result, the motor temperature at the current time is obtained and output each time 1 second elapses in the period P2. The same processing as in the periods P1, P2 is executed for each of the periods P3, P4, P5, and therefore calculation and output of motor temperature is executed for every 1 second unit.

If it is determined that conveyance of the Nth (here, the first) document D is complete (“Yes” in step S21), processing proceeds to step S23 in FIG. 11.

In step S23, it is determined whether or not there is a document D to be transported next. The determination of whether or not there is a next document D is made by a document presence/absence sensor (not illustrated) or the like detecting a document D that still remains on the document feed tray 40a.

If it is determined that there is a document D to be transported next (“Yes” in step S23), after 1 second elapses (step S24), the motor cooling rate D is acquired (step S25). The motor cooling rate D (° C./s) is acquired by reading from the motor temperature change rate table 82 (FIG. 6). Then the acquired motor cooling rate D is subtracted from the motor temperature Ta to obtain a new value for the motor temperature Ta (step S26).

The motor cooling rate D indicates an amount of decrease in motor temperature in a 1 second unit, and therefore the motor temperature Ta at the current time can be obtained by subtracting the motor cooling rate D from the motor temperature Ta 1 second previously.

Then, after motor temperature information indicating the current motor temperature Ta is output to the temperature increase suppression operation instruction unit 57 (step S27), it is determined whether or not there is a next sheet feed instruction (step S28), in this example a sheet feed instruction for the second document D (time t8 illustrated in FIG. 8). If it is determined that there is no next sheet feed instruction (“No” in step S28), the processing in steps S24 to S28 is repeated.

A period from completion of conveying the first document to a start of feeding the second document is a period in which motor temperature drops (corresponding to the period P6 illustrated in FIG. 8), and the motor temperature becomes lower than it was at time t7.

If there is a next sheet feed instruction (“Yes” in step S28), the variable N is incremented by “1” to obtain a new value for the variable N, in this example 2 (step S30), and processing returns to step S13, illustrated in FIG. 10. In step S13, along with feeding the second document D, document information is acquired. If it is known that the document information for the first document D and the second document D is the same, step S13 need not be executed and the document information for the first document D may be used.

According to the processing in steps S13 to S22, the motor temperature in a period from a start of feeding the second document D to conveyance completion is calculated and output in 1 second units. After transport of the second document D is complete (“Yes” in step S21), if it is determined that there is no next document to be conveyed (“No” in step S23), the processing ends.

### (8) Temperature Increase Suppression Operation Instruction Processing

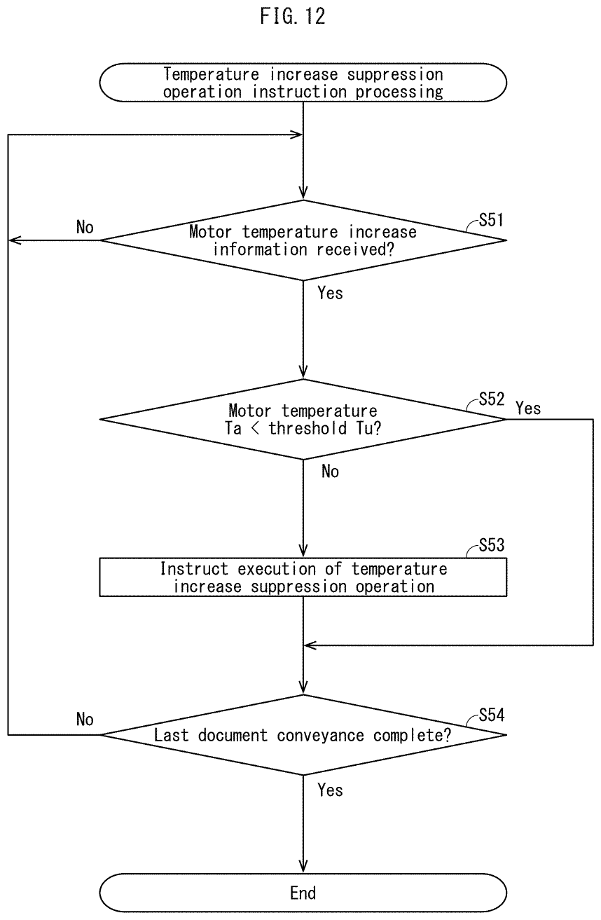

FIG. 12 is a flowchart illustrating temperature increase suppression operation instruction processing. The temperature increase suppression operation instruction processing is executed by the temperature increase suppression operation instruction unit 57 from the start of feeding the first document D to the end of conveyance of a last document D.

As illustrated in FIG. 12, whether or not the motor temperature information is received from the motor temperature calculation unit 84 is determined (step S51). The motor temperature information is motor temperature information output from the motor temperature calculation unit 84 at or immediately before the time of step S51.

If it is determined that motor temperature information has been received (“Yes” in step S51), it is determined whether or not the current motor temperature Ta included in the motor temperature information is lower than a threshold value Tu (step S52). The threshold value Tu is set in advance to 105° C., as described above, but of course the threshold value Tu is not limited to this example.

If it is determined that the motor temperature Ta is less than the threshold value Tu (“Yes” in step S52), processing proceeds to step S54. In step S54, it is determined whether or not a last document conveyance is complete. If it is determined that the last document conveyance is not complete (“No” in step S54), processing returns to step S51 to determine whether or not new motor temperature information has been received. While the motor temperature Ta remains lower than the threshold value Tu, steps S51 and S52 return “Yes” results, and step S54 is repeatedly executed.

However, if the motor temperature Ta increases and the motor temperature Ta becomes equal to or greater than the threshold value Tu (“No” in step S52), the first motor controller 54 is instructed to execute the temperature increase suppression operation (step S53), and processing proceeds to step S54.

When the first motor controller 54 receives an instruction to execute the temperature increase suppression operation, the first motor controller 54 executes the temperature increase suppression operation instead of normal document conveyance. Even when switched to the temperature increase suppression operation, the motor temperature is calculated by the above motor temperature calculation processing. That is, in the temperature increase suppression operation, as described above the document feed interval (corresponding to the period P6 illustrated in FIG. 8) is made longer than in normal document conveyance, and while motor temperature is dropping, the motor temperature in the period P6 can be calculated the same way as in normal document conveyance according to the processing of steps S24 to S28 illustrated in FIG. 11.

### (9) Embodiment and Reference Example Motor Temperature

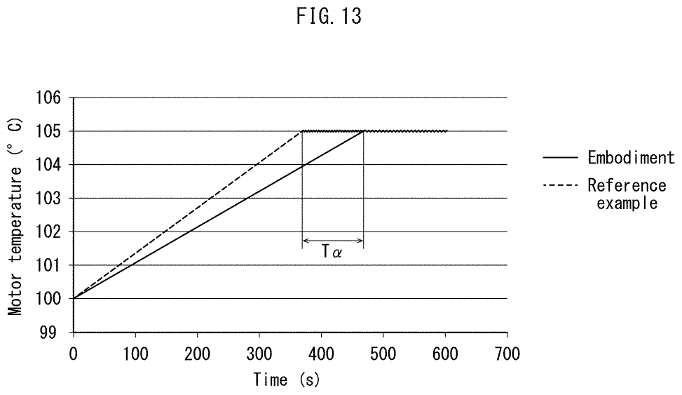

FIG. 13 is a graph schematically illustrating temperature increase of a motor of an embodiment and a reference example, with the horizontal axis indicating time (s) and the vertical axis indicating motor temperature (° C.).

Here, the solid line graph of the embodiment is obtained when motor temperature is calculated by applying the motor temperature increase rate Q and the motor cooling rate D corresponding to the document type, size, and conveyance speed for each of the periods P1 to P6 to the calculation method described above.

On the other hand, the broken line graph of the reference example is obtained when motor temperature is calculated without taking into consideration the document type, size, or conveyance speed, applying the worst conditions in which motor temperature increases the most, i.e., the largest motor temperature increase rate Q in all periods P1 to P5, to the calculation of motor temperature.

In the graphs for both the embodiment and the reference example, the feed start time of the first document D is 0 seconds, and as time passes for 100 seconds, 200 seconds . . . , the number of documents conveyed increases as the second, third . . . document is fed, and motor temperature increases with this passage of time.

Looking at both graphs, the motor temperature increases over time starting at 100° C. at the motor initial temperature TO, but the motor temperature increase rate Q is higher in the reference example than in the embodiment, and therefore the motor temperature of the reference example reaches the threshold value (105° C.) earlier by a time Ta (approximately 100 seconds). When the motor temperature reaches the threshold value, the temperature increase suppression operation starts.

Here, the temperature increase suppression operation is as follows. When a document D is conveyed for a defined time, for example 6 seconds from a time when the motor temperature is Tx, the drive motor 61 is temporarily stopped, interrupting document conveyance. The motor temperature that increased over these 6 seconds is 61. When the motor temperature drops to Tx due to the temporary stop of the drive motor 61 (motor temperature drop), an operation of resuming rotation of the drive motor 61 and conveyance of the document D is executed and the process repeats.

In this operation, the shorter the time required for decreasing motor temperature, the larger the number of documents that can be conveyed per unit time, thereby improving productivity of document reading accordingly.

In temporarily stopping the drive motor 61, instead of completely cutting off supplied current, a control is used of switching a current value up to that time (peak value: 1.0 A) to a smaller current value to activate a self-holding function of the stepping motor, thereby maintaining a stop position (preventing rotation of a motor shaft).

As the cooling rate D during the temporary stop, different magnitudes are applied for the embodiment and the reference example. This is because according to the embodiment, document size is known from the document information, and when size is relatively small such as A4, a length in the document conveyance direction is short (210 mm), and therefore even when document conveyance is temporarily stopped, the trailing end of the document D does not protrude outside the device. More specifically, the trailing end of the document D is in a state in which it is conveyed slightly downstream from the feed roller 41 at the time of the temporary stop. As a result, a user will not perform an operation of gripping and pulling the trailing end of the document D at the time of the temporary stop. Accordingly, the peak value of current to be supplied to the drive motor 61 during the temporary stop can be lowered to 0.2 A, for example.

On the other hand, according to the reference example, document size is not considered, and therefore even if the actual size is A4, a maximum size, for example A3, is assumed to be under conveyance, and the peak value of current to be supplied to the drive motor during the temporary stop is determined based on this assumption. Large documents are long in the document conveyance transport direction (420 mm for A3), and therefore when document conveyance is temporarily stopped, the trailing end of the document D protrudes outside the device, and there is a risk that a user will grip and pull the trailing end of the document D during the temporary stop. For this reason, it is necessary to increase a holding force during the temporary stop, for example by setting the peak current to 0.3 A.

The larger the peak value of current supplied to the drive motor 61 during the temporary stop, the larger the amount of heat generated by the drive motor 61, and therefore the cooling rate D decreases accordingly. For example, according to the embodiment, 0.03898° C./s corresponds to a current value of 0.2 A, and according to the reference example, 0.03438° C./s corresponds to a current value of 0.3 A.

The temperature increase rate Q during document conveyance over 6 seconds is also smaller for the embodiment than the reference example. According to the embodiment, when a document size of A4 is acquired from document information, for example, a temperature increase rate Qa of 0.0099 corresponding to the period P4 is used. According to the reference example, when the document size is assumed to be A3, a temperature increase rate Qb of 0.0135 corresponding to the period P4 is used.

The motor temperature increase M when the document D is conveyed for 6 seconds is 0.059 (6×Qa) for the embodiment and 0.081 (6×Qb) for the reference example. By dividing the motor temperature increase M by the cooling rate D, a time Tδ required for the temperature M to drop can be obtained. The time Tδ is 1.5 seconds (0.059/0.03898) for the embodiment and 2.4 seconds (0.081/0.03438) for the reference example.

The time Tδ corresponds to the document conveyance interval, and therefore a value Ua obtained by dividing the document conveyance time of 6 seconds by (time Tδ+6) indicates document conveyance productivity. For the embodiment, Ua is 0.8 and for the reference example Ua is 0.71. In other words, in the temperature increase suppression operation, when compared to normal conveyance operation, productivity drops to 71% for the reference example, and drops to 80% for the embodiment, meaning that the embodiment realizes a control that decreases the amount productivity is impaired.

According to the reference example, the motor temperature increase rate is calculated using the same worst value for all types of document, and therefore the reference example can be said to be substantially the same as conventional structures in which an addition constant is uniformly determined in units of operation modes such as scanning and copying. Thus, the embodiment has an effect of improving accuracy of estimating motor temperature and improving document image reading productivity over prior art.

The present disclosure is not limited to a sheet conveyance device, and includes an image reading device and an image forming device incorporating the sheet conveyance device, and includes a temperature estimation method for estimating a temperature of a motor that rotates a conveyance roller by applying a drive force to a conveyance roller that conveys a sheet. Further, the method may be a program executable by a computer. Further, the program may be recorded on a computer-readable storage medium such as a magnetic disk such as a flexible disk, an optical storage medium such as a digital versatile disc read-only memory (DVD-ROM) or the like, a flash memory storage medium, or the like. Such a program may be produced, transferred, etc., in the form of the storage medium, or may be transmitted and supplied via a wired or wireless network such as the Internet, broadcasting, telecommunication lines, satellite communication, or the like.

### (10) Modifications

A description has been provided based on an embodiment, but of course the present disclosure is not limited to the embodiment described above, and includes the following modifications.

(10-1) According to an embodiment described above, an example is described of using a stepping motor as a motor that rotates conveyance rollers such as the resist roller pair 43 at a target constant speed, but the motor used is not limited to this example. Any motor may be used that has a characteristic of changing effective current flowing through an excited coil depending on changes to load torque, when motor load torque changes due to changes in rotation load of conveyance rollers and the like while maintaining rotation speed of the conveyance rollers and the like at a constant speed. For example, an AC motor may be used.

(10-2) According to an embodiment described above, an example is described of the electromagnetic clutches 71, 72 disposed on the drive transmission path 70 of the first conveyance mechanism 101, but a structure that does not use electromagnetic clutches may be used. Regardless of presence or absence of an electromagnetic clutch, rotation torque of conveyance rollers changes according to changes in type, size, etc., of a document D to be conveyed, and load torque of the drive motor 61 changes according to the changes in the rotation torque of the conveyance rollers.

Further, even with the same type and size of document D, size of the load amount during document conveyance Ld changes depending on whether an electromagnetic clutch is on or off, and the size of the load torque of the drive motor 61 also changes, and therefore application of the motor temperature estimation method is not limited to situations in which types, sizes, etc., of the documents D are different.

Further, a structure may be used in which a portion of rotational drive of the drive motor 61 is used for raising and lowering operations in which the feed roller 41 is lowered to a feed position where it contacts a document D when feeding documents D from the feed tray 40a and the feed roller 41 is moved up to a retracted position away from the document D when feeding of the documents D ends. According to such a structure, the load torque of the drive motor 61 is larger during raising/lowering operations of the feed roller 41 than when raising/lowering operations are not performed. By determining in advance a temperature increase rate to apply during the raising/lowering operations of the feed roller 41, the motor temperature during the raising/lowering operations can be accurately determined.

(10-3) According to an embodiment described above, in steps S16 to S18 of the motor temperature calculation processing, the motor temperature increase rate Q is acquired at intervals in each of the periods P1 to P5, specifically at 1 second intervals, and the acquired motor temperature increase rate Q is added to a cumulative value to obtain the motor temperature increase from a start time, but the motor temperature calculation processing is not limited to this example. The motor temperature calculation processing includes acquiring the motor temperature increase rate Q corresponding to a period just once at any timing during the period, and multiplying the acquired motor temperature increase rate Q by an elapsed time from the start of the period to obtain a temperature to add to a cumulative value of temperature acquired over time.

(10-4) According to an embodiment described above, an example is described of applying a cooling rate while current supply to the drive motor 61 is cut off as the cooling rate D when the drive motor 61 is stopped, but the cooling rate D is not limited to this example. For example, when a situation occurs in which a document D is temporarily stopped during document conveyance, a holding control may execute the holding function described above.

During this holding control period, the motor temperature can be estimated by using a cooling rate predetermined for the holding control. The cooling rate during the holding control is determined by the current value, but is a little smaller than the cooling rate D during current interruption (0.0447), for example 0.0343.

As a situation in which the document D is temporarily stopped, a situation may be considered in which internal memory (not illustrated) is full when image data obtained by reading an Nth document D is storage in the memory, and therefore the (N+1)th document D is stopped immediately the reading position 1a to wait for memory to be released. When memory is released, the temporary stop ends, and conveyance of the document D resumes to execute the reading operation.

(10-5) According to an embodiment described above, a structure in which an MFP includes the motor temperature change rate table 82 is described, but the present disclosure is not limited to this example. For example, information indicating the motor temperature increase rate Q and the cooling rate D corresponding to load amounts during document conveyance for document types, sizes, and the like may be acquired from an external terminal device (not illustrated) via a network.

(10-6) According to an embodiment described above, the sheet conveyance device is applied to the ADF 40 that conveys the document D as an example of a sheet, but the present disclosure is not limited to this example of a sheet.

In the image former 2 and the sheet feeder 3, the sheet conveyance device/method can be used where conveyance rollers rotationally drive by a motor convey sheets S. Further, the sheet conveyance device/method is not limited to use in an image forming device or image reading device, and can be applied to any sheet conveyance device that conveys a sheet. Further, numerical values such as the motor temperature increase rate, cooling rate, and effective current value are of course not limited to the examples provided, and appropriate values may be set in advance according to device structure and configuration.

Further, contents of any described embodiment and modification may be combined in any possible combination.

### <Review>

The embodiments and modifications described illustrate one aspect of the present disclosure for solving the technical problems described under the “SUMMARY” heading, and the following is a review of the embodiments and modifications.

That is, according to an aspect of the present disclosure, a sheet conveyance device includes: a conveyance roller that conveys a sheet; a motor that rotationally drives the conveyance roller at a constant speed; and a CPU that: periodically acquires temperature increase rates for the motor from a start of sheet conveyance, the temperature increase rates depending on magnitudes of effective current applied to the motor, the effective current depending on loads during sheet conveyance; and estimates a current temperature of the motor based on a cumulative value calculated from the temperature increase rates and time elapsed from the start of sheet conveyance; and a controller that executes a motor temperature control based on the estimated temperature of the motor.

According to an embodiment, the CPU instructs the controller to execute a defined temperature increase suppression operation for suppressing temperature increase of the motor instead of a normal sheet conveyance operation when the CPU estimates that the current temperature of the motor is equal to or greater than a threshold value.

According to an embodiment, the loads are determined in advance for each type, size, or combination thereof of sheet to be conveyed.

According to an embodiment, among the types of sheet, a thicker sheet corresponds to a higher temperature increase rate for the motor than a thinner sheet.

According to an embodiment, among the sizes of sheet, a larger sheet corresponds to a higher temperature increase rate for the motor than a smaller sheet.

According to an embodiment, the sheet conveyance device further includes: when the conveyance roller is a first conveyance roller, a second conveyance roller positioned upstream or downstream of the first conveyance roller in a sheet conveyance direction and rotated by a part of a drive force from the motor to convey the sheet; and a clutch that is disposed in a transmission path of the drive force from the motor to either the first conveyance roller or the second conveyance roller, the clutch switching on and off transmission of the drive force. Further, the loads include rotational loads of the first conveyance roller and the second conveyance roller, magnitudes of the loads are different between a period in which the clutch switches on transmission of the drive force and a period in which the clutch switches off transmission of the drive force, the temperature increase rates for the motor have a higher value in a period in which the clutch switches on transmission of the drive force than in a period in which the clutch switches off transmission of the drive force, and the CPU estimates the current temperature using a first temperature increase rate corresponding to the period in which the clutch switches on transmission of the drive force and a second temperature increase rate corresponding to the period in which the clutch switches off transmission of the drive force.

According to an embodiment, the CPU estimates the current temperature of the motor by adding the cumulative value to an initial temperature for the motor at the start of sheet conveyance, and calculates the cumulative value by summing temperatures each obtained by multiplying an acquired temperature increase rate by a time until the next acquisition of a temperature increase rate.

According to an embodiment, the initial temperature is a predetermined temperature.

According to an embodiment, the CPU further acquires a cooling rate for the motor corresponding to when the motor is stopped due to completion of conveyance of one sheet, and the CPU estimates the current temperature of the motor while stopped based on an estimated temperature at a start of the stop, an elapsed time from the start of the stop, and the cooling rate.

According to an embodiment, the motor is a stepping motor.

According to an aspect of the present disclosure, a sheet conveyance device includes: a conveyance roller that conveys a sheet; a stepping motor that rotationally drives the conveyance roller; a CPU that: periodically acquires temperature increase rates for the stepping motor from a start of sheet conveyance, the temperature increase rates depending on magnitudes of effective current applied to the stepping motor, the effective current depending on sheet conveyance speed; and estimates a current temperature of the stepping motor based on a cumulative value calculated from the temperature increase rates and time elapsed from the start of sheet conveyance; and a controller that executes a motor temperature control based on the estimated temperature of the stepping motor.

According to an aspect of the present disclosure, an image reading device includes: a sheet conveyance device including: a conveyance roller that conveys a sheet; a motor that rotationally drives the conveyance roller at a constant speed; a CPU that: periodically acquires temperature increase rates for the motor from a start of sheet conveyance, the temperature increase rates depending on magnitudes of effective current applied to the motor, the effective current depending on loads during sheet conveyance; and estimates a current temperature of the motor based on a cumulative value calculated from the temperature increase rates and time elapsed from the start of sheet conveyance; and a controller that executes a motor temperature control based on the estimated temperature of the motor; and a reading unit that reads an image on the sheet conveyed by the sheet conveyance device.

According to the above, motor temperature can be more accurately estimated than when using uniform constants, by using motor temperature increase rates determined from magnitudes of effective current of the motor that change according to changes in load during sheet conveyance.

Although one or more embodiments of the present invention have been described and illustrated in detail, the disclosed embodiments are made for the purposes of illustration and example only and not limitation. The scope of the present invention should be interpreted by the terms of the appended claims.

What is claimed is:

1. A sheet conveyance device comprising:
a conveyance roller that conveys a sheet;
a motor that rotationally drives the conveyance roller at a constant speed;
a central processing unit (CPU) that:
periodically acquires temperature increase rates for the motor from a start of sheet conveyance, the temperature increase rates depending on magnitudes of effective current applied to the motor, the effective current depending on loads during sheet conveyance; and
estimates a current temperature of the motor based on a cumulative value calculated from the temperature increase rates and time elapsed from the start of sheet conveyance; and
a controller that executes a motor temperature control based on the estimated temperature of the motor.

2. The sheet conveyance device of claim 1, wherein
the CPU instructs the controller to execute a defined temperature increase suppression operation for suppressing temperature increase of the motor instead of a normal sheet conveyance operation when the CPU estimates that the current temperature of the motor is equal to or greater than a threshold value.

3. The sheet conveyance device of claim 1, wherein
the loads are determined in advance for each type, size, or combination thereof of sheet to be conveyed.

4. The sheet conveyance device of claim 3, wherein
among the types of sheet, a thicker sheet corresponds to a higher temperature increase rate for the motor than a thinner sheet.

5. The sheet conveyance device of claim 3, wherein
among the sizes of sheet, a larger sheet corresponds to a higher temperature increase rate for the motor than a smaller sheet.

6. The sheet conveyance device of claim 1, further comprising:
when the conveyance roller is a first conveyance roller, a second conveyance roller positioned upstream or downstream of the first conveyance roller in a sheet conveyance direction and rotated by a part of a drive force from the motor to convey the sheet; and
a clutch that is disposed in a transmission path of the drive force from the motor to either the first conveyance roller or the second conveyance roller, the clutch switching on and off transmission of the drive force, wherein
the loads include rotational loads of the first conveyance roller and the second conveyance roller,
magnitudes of the loads are different between a period in which the clutch switches on transmission of the drive force and a period in which the clutch switches off transmission of the drive force,
the temperature increase rates for the motor have a higher value in a period in which the clutch switches on transmission of the drive force than in a period in which the clutch switches off transmission of the drive force, and
the CPU estimates the current temperature using a first temperature increase rate corresponding to the period in which the clutch switches on transmission of the drive force and a second temperature increase rate corresponding to the period in which the clutch switches off transmission of the drive force.

7. The sheet conveyance device of claim 1, wherein
the CPU estimates the current temperature of the motor by adding the cumulative value to an initial temperature for the motor at the start of sheet conveyance, and calculates the cumulative value by summing temperatures each obtained by multiplying an acquired temperature increase rate by a time until the next acquisition of a temperature increase rate.

8. The sheet conveyance device of claim 7, wherein
the initial temperature is a predetermined temperature.

9. The sheet conveyance device of claim 1, wherein
the CPU further acquires a cooling rate for the motor corresponding to when the motor is stopped due to completion of conveyance of one sheet, and
the CPU estimates the current temperature of the motor while stopped based on an estimated temperature at a start of the stop, an elapsed time from the start of the stop, and the cooling rate.

10. The sheet conveyance device of claim 1, wherein
the motor is a stepping motor.

11. A sheet conveyance device comprising:
a conveyance roller that conveys a sheet;
a stepping motor that rotationally drives the conveyance roller;
a central processing unit (CPU) that:
periodically acquires temperature increase rates for the stepping motor from a start of sheet conveyance, the temperature increase rates depending on magnitudes of effective current applied to the stepping motor, the effective current depending on sheet conveyance speed; and
estimates a current temperature of the stepping motor based on a cumulative value calculated from the temperature increase rates and time elapsed from the start of sheet conveyance; and
a controller that executes a motor temperature control based on the estimated temperature of the stepping motor.

12. An image reading device comprising:
a sheet conveyance device comprising:
a conveyance roller that conveys a sheet;
a motor that rotationally drives the conveyance roller at a constant speed;
a central processing unit (CPU) that:
periodically acquires temperature increase rates for the motor from a start of sheet conveyance, the temperature increase rates depending on magnitudes of effective current applied to the motor, the effective current depending on loads during sheet conveyance; and
estimates a current temperature of the motor based on a cumulative value calculated from the temperature increase rates and time elapsed from the start of sheet conveyance; and
a controller that executes a motor temperature control based on the estimated temperature of the motor; and
a reading unit that reads an image on the sheet conveyed by the sheet conveyance device.
